(19) United States
(12) Patent Application Publication
(10) Pub. No.: US 2025/0276740 A1
(43) Pub. Date: Sep. 4, 2025

(54) VEHICLE LOWER STRUCTURE

(71) Applicant: TOYOTA JIDOSHA KABUSHIKI KAISHA, Toyota-shi (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi (JP); Kai MIYAMURA, Toyota-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/052,629

(22) Filed: Feb. 13, 2025

(30) Foreign Application Priority Data
Mar. 1, 2024 (JP) 2024-031449

(51) Int. Cl. B62D 25/20; B60K 1/04

(52) U.S. Cl. CPC B62D 25/20; B60K 1/04; B60K 2001/0438

(57) ABSTRACT

A vehicle lower structure includes a pair of vehicle body frame members, an intermediate member at least a portion of which is disposed between the pair of vehicle body frame members, a power storage device disposed below the intermediate member, a seat disposed above the intermediate member, and a reinforcing member disposed inside the intermediate member or on an upper surface of the intermediate member, wherein the vehicle lower structure has a region in which the reinforcing member is not provided below the seat in a vehicle up/down direction.

### CROSS REFERENCE TO RELATED APPLICATIONS

This nonprovisional application is based on Japanese Patent Application No. 2024-031449 filed on Mar. 1, 2024 with the Japan Patent Office, the entire contents of which are hereby incorporated by reference.

### BACKGROUND

### Field

The present disclosure relates to a vehicle lower structure.

### Description of the Background Art

As disclosed in Japanese Patent Laying-Open No. 2020-142589, it is required to ensure rigidity of a vehicle lower structure, and to suppress an increase in weight of the vehicle lower structure as much as possible.

### SUMMARY

An object of the present disclosure is to provide a vehicle lower structure that can ensure rigidity of the vehicle lower structure and suppress an increase in weight of the vehicle lower structure.

A vehicle lower structure in the present disclosure includes a pair of vehicle body frame members, a first intermediate member at least a portion of which is disposed between the pair of vehicle body frame members, a power storage device disposed below the first intermediate member, a first seat disposed above the first intermediate member, and a first reinforcing member disposed inside the first intermediate member or on an upper surface of the first intermediate member, wherein the vehicle lower structure has a region in which the first reinforcing member is not provided below the first seat in a vehicle up/down direction.

According to the above configuration, even if rigidity of only the first intermediate member is insufficient to receive a load, the presence of the first reinforcing member allows the first intermediate member and the first reinforcing member to cooperate to receive the load of an occupant, and it is possible to ensure rigidity by the presence of the first reinforcing member, and to suppress an increase in weight of the vehicle lower structure by the presence of the region in which the first reinforcing member is not provided below the first seat in the vehicle up/down direction.

In the above disclosure, the vehicle lower structure may include a lower frame including a pair of side members, a front member connecting front portions of the pair of side members, a rear member connecting rear portions of the pair of side members, and a cross member connecting intermediate portions of the pair of side members in a vehicle front/rear direction, wherein the pair of vehicle body frame members may be any two members selected from the pair of side members, the front member, and the cross member; the first intermediate member may be disposed to fill a space formed by the pair of side members, the front member, and the cross member, inside these members; the first reinforcing member may have a first support region; and when a first right reference line and a first left reference line extending in the vehicle front/rear direction along a right end portion and a left end portion of the first seat in a vehicle width direction are defined respectively, and the first support region is projected upward in a vertical direction, a first projection image formed by projection thereof may be located on a front side relative to a front end portion of the first seat, and may be located between the first right reference line and the first left reference line.

According to the above configuration, the first intermediate member can be disposed without any gap in a space formed by a plurality of members among the pair of side members, the front member, the cross member, and the rear member, inside the plurality of members.

In the above disclosure, the first reinforcing member may be provided to extend from the front member toward a rear side in the vehicle front/rear direction.

According to the above configuration, since the first reinforcing member is bonded to the front member, the first reinforcing member can resist a greater load.

In the above disclosure, the lower frame may include a plurality of the cross members; the vehicle lower structure may further include a second intermediate member disposed to fill a space formed by the pair of side members and the plurality of the cross members, inside these members; the power storage device may be disposed below both the first intermediate member and the second intermediate member; the vehicle lower structure may further include a second seat, and a second reinforcing member disposed inside the second intermediate member or on an upper surface of the second intermediate member; the second reinforcing member may have a second support region; and when a second right reference line and a second left reference line extending in the vehicle front/rear direction along a right end portion and a left end portion of the second seat in the vehicle width direction are defined respectively, and the second support region is projected upward in the vertical direction, a second projection image formed by projection thereof may be located on a front side relative to a front end portion of the second seat, and may be located between the second right reference line and the second left reference line.

According to the above configuration, even if rigidity of only the second intermediate member is insufficient to receive a load, the presence of the second reinforcing member allows the second intermediate member and the second reinforcing member to cooperate to receive the load of an occupant, and it is possible to ensure rigidity by the presence of the second reinforcing member, and to suppress an increase in the weight of the vehicle lower structure.

In the above configuration, the second reinforcing member may be provided to extend from any of the plurality of the cross members toward a front side or a rear side in the vehicle front/rear direction.

According to the above configuration, since the second reinforcing member is bonded to the cross member, the second reinforcing member can resist a greater load.

In the above configuration, the power storage device may include a power storage module including a plurality of power storage cells arranged in a horizontal direction, a case having a top plate and a bottom plate and accommodating the power storage module, and a rigid board disposed between the top plate and the power storage module, and when the first reinforcing member is projected downward in the vertical direction, at least a portion of a third projection image formed by projection thereof may be located not to overlap the rigid board.

According to the above configuration, the fact that the third projection image of the first reinforcing member is located not to overlap the rigid board means that the rigid board is not present at that location. Even if there is a portion where the rigid board is not present as described above, rigidity can be ensured by the presence of the first reinforcing member. Since the presence of the rigid board is omitted, the vehicle lower structure can be manufactured at a lower cost correspondingly.

In the above configuration, the power storage device may further include a cushion member disposed between the top plate and the power storage module, and at least a portion of the third projection image may be located to overlap the cushion member.

According to the above configuration, even if there is a portion where the rigid board is not present as described above, the cushion member is present to fill such a portion. The cushion member can be constituted by a member which is less expensive than the rigid board and an adhesive, and in that case, the vehicle lower structure can be manufactured at a lower cost.

In the above configuration, the rigid board may have an underlying portion underlying the third projection image, the underlying portion of the rigid board may not be bonded to the top plate, and at least a portion of the rigid board other than the underlying portion may be bonded to the top plate.

According to the above configuration, since the adhesive is not present between the underlying portion of the rigid board and the top plate, the vehicle lower structure can be manufactured at a lower cost correspondingly. Further, in a non-bonded range of the underlying portion, a space is formed, because the adhesive is not present. When a load is inputted from an upper surface side of a floor, the floor is deformed, the intermediate member and the like are also deformed, and thereafter the top plate is also deformed. By absorbing (stroking) displacement associated with such deformation in the space, input of the load to the rigid board can be reduced.

In the above disclosure, the rigid board may have an underlying portion underlying the third projection image, the underlying portion of the rigid board may be bonded to the top plate, and at least a portion of the rigid board other than the underlying portion may not be bonded to the top plate.

Also according to the above configuration, since the adhesive is not present, the vehicle lower structure can be manufactured at a lower cost correspondingly. Further, since the underlying portion is likely to be located under the occupant's feet, the rigid board can be reinforced by bonding the underlying portion of the rigid board to the top plate. On the other hand, a portion of the rigid board not underlying the third projection image (a non-underlying portion) below the seat is less likely to directly receive a load generated when the occupant taps his or her foot. Therefore, by not bonding the non-underlying portion of the rigid board to the top plate, a space is formed at this position, and this space can absorb variation in vertical position between the cross member and the like and the power storage device and displacement due to relative vibration.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view showing a vehicle 1 including a vehicle lower structure 10 in a first embodiment.

FIG. 2 is a plan view showing a vehicle compartment 13 and vehicle lower structure 10 of vehicle 1 in the first embodiment.

FIG. 3 is a cross sectional view of vehicle lower structure 10 in the first embodiment as viewed from a front side of vehicle 1, which corresponds to a cross sectional view taken along a line III-III in FIG. 4 and viewed in a direction indicated by arrows.

FIG. 4 is a cross sectional view of vehicle lower structure 10 in the first embodiment as viewed from a left side of vehicle 1, which corresponds to a cross sectional view taken along a line IV-IV in FIG. 3 and viewed in a direction indicated by arrows.

FIG. 5 is an enlarged view of a portion in FIG. 4.

FIG. 6 is an exploded cross sectional view of vehicle lower structure 10 in the first embodiment, which corresponds to FIG. 4.

FIG. 7 is an exploded perspective view of vehicle lower structure 10 in the first embodiment.

FIG. 8 is a cross sectional view showing a vehicle lower structure 10A in a second embodiment, which corresponds to FIG. 5 in the first embodiment.

FIG. 9 is a cross sectional view showing a vehicle lower structure 10B in a third embodiment, which corresponds to FIG. 5 in the first embodiment.

FIG. 10 is a cross sectional view showing a vehicle lower structure 10C in a fourth embodiment, which corresponds to FIG. 5 in the first embodiment.

FIG. 11 is a cross sectional view showing a vehicle lower structure 10D in a fifth embodiment, which corresponds to FIG. 5 in the first embodiment.

FIG. 12 is a cross sectional view showing a vehicle lower structure 10E in a sixth embodiment, which corresponds to FIG. 5 in the first embodiment.

### DESCRIPTION OF THE PREFERRED EMBODIMENTS

Hereinafter, embodiments of the present disclosure will be described. When the number, amount, or the like is mentioned in the embodiments described below, the scope of the present disclosure is not necessarily limited to that number, amount, or the like unless otherwise specified. Each component is not necessarily essential to the present disclosure unless otherwise specified. The same parts and corresponding parts will be designated by the same reference numerals, and the same description may not be repeated.

Arrows F, B, U, D, L, and R in the drawings used in the following description indicate directions with respect to a vehicle, and arrow F indicates a “forward direction”, arrow B indicates a “backward direction”, arrow U indicates an “upward direction”, arrow D indicates a “downward direction”, arrow L indicates a “left direction”, and arrow R indicates a “right direction”.

### First Embodiment

### (Vehicle 1)

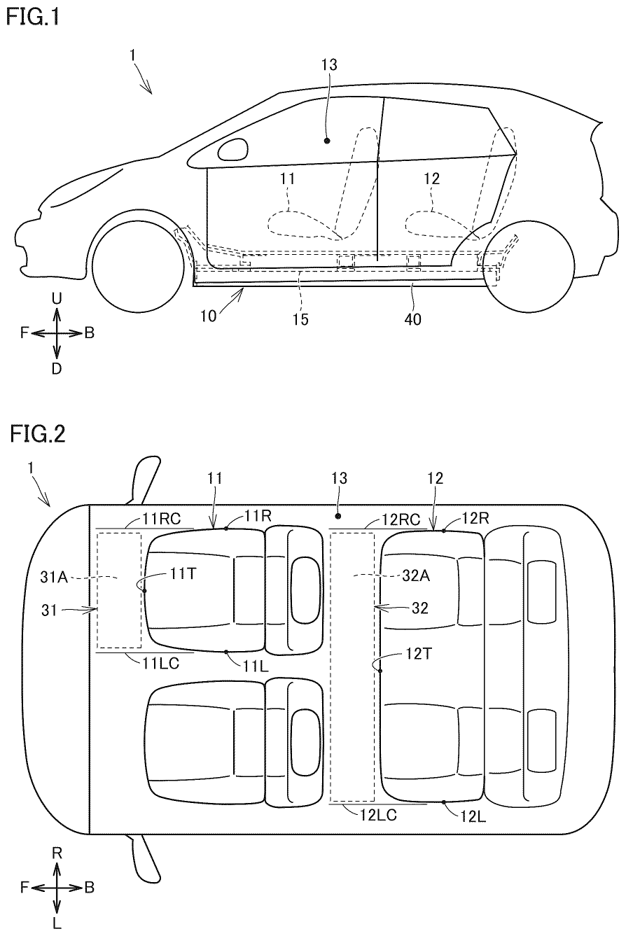

Referring to FIGS. 1 to 7, a vehicle 1 including a vehicle lower structure 10 in a first embodiment will be described. FIG. 1 is a side view showing vehicle 1, and FIG. 2 is a plan view showing a vehicle compartment 13 and vehicle lower structure 10 of vehicle 1.

Vehicle 1 is, for example, an electrically powered vehicle such as an electric vehicle or a hybrid vehicle that can be driven by a motor. Vehicle 1 includes vehicle compartment 13 and vehicle lower structure 10.

### (Vehicle Lower Structure 10)

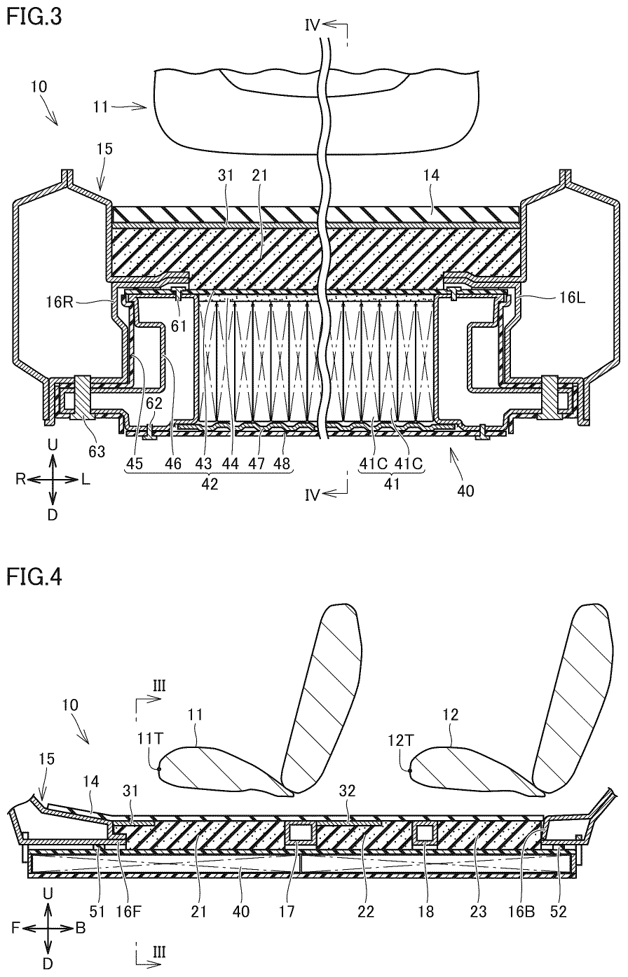

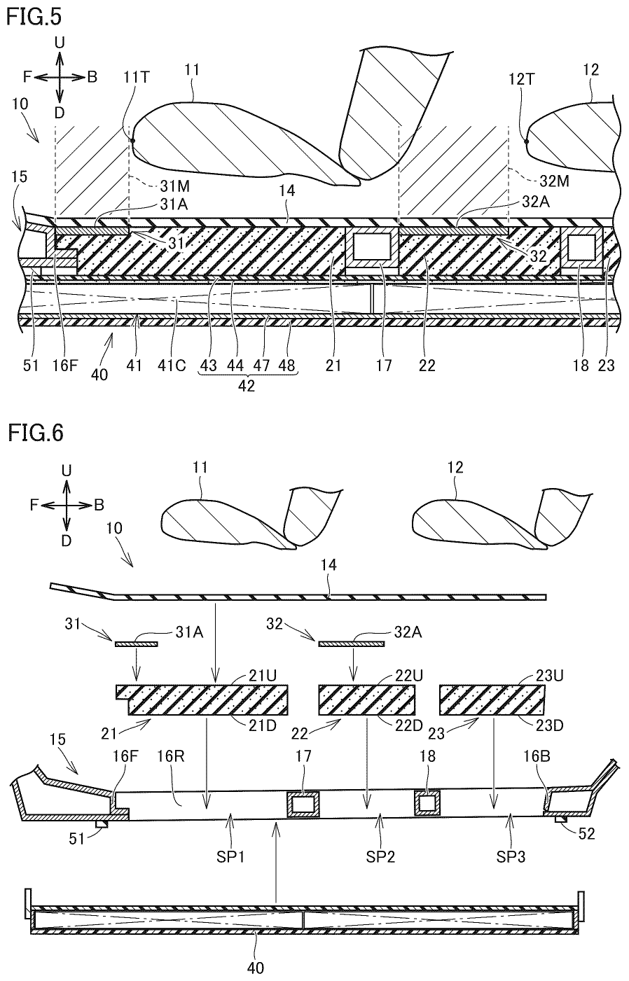

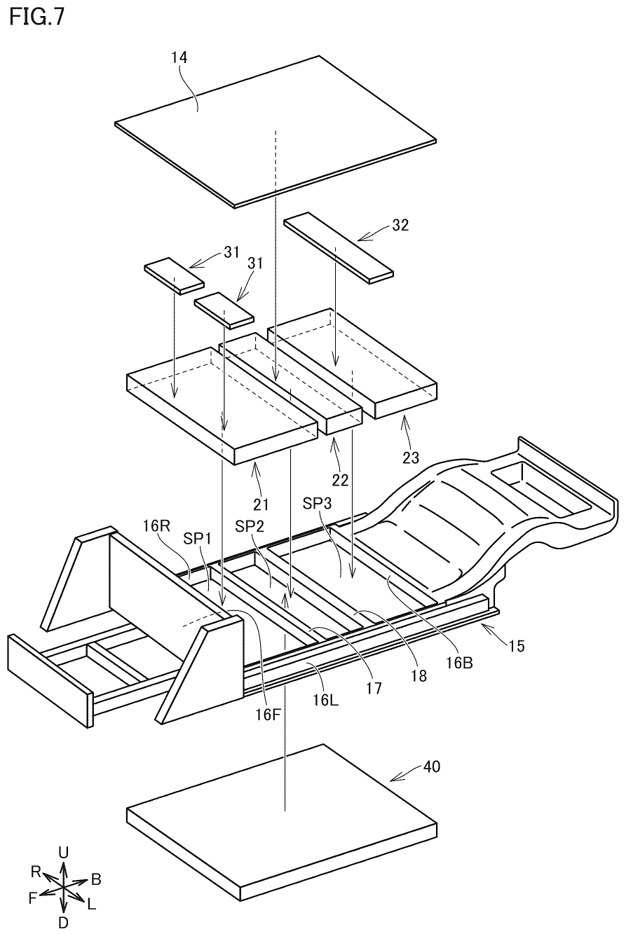

FIG. 3 is a cross sectional view of vehicle lower structure 10 as viewed from a front side of vehicle 1, which corresponds to a cross sectional view taken along a line III-III in FIG. 4 and viewed in a direction indicated by arrows. FIG. 4 is a cross sectional view of vehicle lower structure 10 as viewed from a left side of vehicle 1, which corresponds to a cross sectional view taken along a line IV-IV in FIG. 3 and viewed in a direction indicated by arrows. FIG. 5 is an enlarged view of a portion in FIG. 4. FIG. 6 is an exploded cross sectional view of vehicle lower structure 10, which corresponds to FIG. 4. FIG. 7 is an exploded perspective view of vehicle lower structure 10.

As shown in FIGS. 3 to 7 (in particular, FIGS. 6 and 7), vehicle lower structure 10 includes seats 11 and 12 in which occupants can sit, a floor carpet 14, intermediate members 21 to 23, reinforcing members 31 and 32, a lower frame 15, and a power storage device 40.

### (Lower Frame 15)

Lower frame 15 (FIG. 7) includes a pair of side members 16L and 16R, a front member 16F, a rear member 16B, and cross members 17 and 18. Front member 16F extends in a vehicle width direction and connects front portions of the pair of side members 16L and 16R. Rear member 16B extends in the vehicle width direction and connects rear portions of the pair of side members 16L and 16R. Each of cross members 17 and 18 also extends in the vehicle width direction and connects intermediate portions of the pair of side members 16L and 16R in a vehicle front/rear direction.

In the present embodiment, vehicle lower structure 10 includes a pair of vehicle body frame members, and at least a portion of intermediate member 21 (a first intermediate member) described later is disposed between the pair of vehicle body frame members. For example, the pair of vehicle body frame members may be any two members selected from the pair of side members 16L and 16R, front member 16F, and cross member 17. In the present embodiment, the pair of side members 16L and 16R, front member 16F, and cross member 17 are disposed in a rectangular frame shape, and a space SP1 (FIGS. 6 and 7) is formed inside these members. Similarly, the pair of side members 16L and 16R and cross members 17 and 18 are disposed in a rectangular frame shape, and a space SP2 is formed inside these members.

The pair of side members 16L and 16R, cross member 18, and rear member 16B are disposed in a rectangular frame shape, and a space SP3 is formed inside these members. Vehicle lower structure 10 is not provided with a member generally called a floor panel or the like, which is constituted by a metal steel plate or the like. Vehicle lower structure 10 penetrates through spaces SP1, SP2, and SP3 in an up/down direction at portions where spaces SP1, SP2, and SP3 are provided.

### (Intermediate Members 21 to 23)

Intermediate member 21 (the first intermediate member), intermediate member 22 (a second intermediate member), and intermediate member 23 are constituted by members including a foamed resin, for example, and each have a block-like shape. Seats 11 described later are disposed above intermediate member 21. Intermediate members 21 to 23 can be constituted by members that are lighter than metal and softer than metal. Intermediate members 21 to 23 have substantially the same sizes and shapes as those of spaces SP1, SP2, and SP3, respectively. Intermediate members 21 to 23 are disposed to fill spaces SP1, SP2, and SP3, respectively (FIGS. 6 and 7).

### (Floor Carpet 14)

Floor carpet 14 is a member forming a portion of vehicle compartment 13 above floor carpet 14. As shown in FIGS. 1 and 2, a pair of seats 11 (first seats) are disposed to be arranged in a right/left direction at positions above floor carpet 14 (positions above intermediate member 21) inside vehicle compartment 13, and seat 12 (a second seat) is disposed behind the seats.

As shown in FIG. 6, floor carpet 14 is disposed above intermediate members 21 to 23. Floor carpet 14 may be disposed to directly contact upper surfaces 21U, 22U, and 23U of intermediate members 21, 22, and 23. Between floor carpet 14 and intermediate members 21 to 23, a fixture for preventing movement of floor carpet 14, a structure for preventing slippage (a hook-and-loop fastener), or the like may be provided as appropriate. Although floor carpet 14 is constituted by one member in vehicle 1 in the present embodiment, floor carpet 14 may be constituted by a plurality of members.

### (Power Storage Device 40)

As shown in FIGS. 3 to 6, power storage device 40 is disposed below intermediate members 21 to 23. Power storage device 40 (FIG. 3) includes a power storage module 41 and a case 42. Power storage module 41 includes a plurality of power storage cells 41C accommodated by case 42 and arranged in a horizontal direction. Power storage cell 41C is configured to include a battery that stores electric power to be supplied to the motor. The plurality of power storage cells 41C may be stacked in the vehicle width direction, or may be stacked in the vehicle front/rear direction.

Case 42 (FIG. 3) has a top plate 43, an adhesive 44, side walls 45, inner walls 46, a support member 47, and a bottom plate 48. Top plate 43, a pair of side walls 45, and bottom plate 48 are made of FRP, for example, these members constitute an outer structure of case 42, and adhesive 44, inner walls 46 and support member 47, and power storage module 41 are disposed in this structure.

Power storage module 41 (each of the plurality of power storage cells 41C) is bonded to top plate 43 with adhesive 44. Inner walls 46 are disposed on both outer sides of power storage module 41 (the plurality of power storage cells 41C) in a stacking direction. Support member 47 has a plate-like shape, and is disposed between power storage module 41 and bottom plate 48. Each inner wall 46 is integrated with top plate 43 by a fixture 61, and is integrated with bottom plate 48 by a fixture 62.

Power storage device 40 configured as described above is fastened to, for example, side members 16L and 16R of lower frame 15, by a plurality of fasteners 63 (FIG. 3). Thereby, power storage device 40 is supported by lower frame 15. Seals 51 and 52 (FIGS. 4 and 6) may be disposed between power storage device 40 (top plate 43) and lower frame 15 (front member 16F, side member 16R).

As shown in FIG. 6, power storage device 40 is disposed below intermediate members 21 to 23. Power storage device 40 (top plate 43) may be disposed to directly contact lower surfaces 21D, 22D, and 23D of intermediate members 21, 22, and 23 (see also FIG. 3).

### (Reinforcing Members 31 and 32)

Reinforcing members 31 and 32 are constituted by members having rigidity higher than that of intermediate members 21 to 23, for example, such as GFRP or metal. In vehicle lower structure 10, reinforcing members 31 (first reinforcing members) and reinforcing member 32 (a second reinforcing member) each having a plate shape are used. Here, reinforcing members 31 are disposed on upper surface 21U of intermediate member 21, and reinforcing member 32 is disposed on upper surface 22U of intermediate member 22.

Reinforcing member 31 is provided to extend from front member 16F toward a rear side in the vehicle front/rear direction. Reinforcing member 31 may be detachably or non-detachably bonded to front member 16F. Here, reinforcing members 31 and 32 are disposed to extend in a plane direction including the vehicle width direction and a vehicle right/left direction.

Vehicle lower structure 10 in the present embodiment is characterized by having a region in which reinforcing member 31 is not provided below seat 11 in a vehicle up/down direction. For example, even when seat 11 is projected downward in a vertical direction, a projection image thereof does not overlap reinforcing member 31. Further, for example, even when seat 12 is projected downward in the vertical direction, a projection image thereof does not overlap reinforcing member 32.

### (Support Region 31A)

For example, reinforcing member 31 has a support region 31A (a first support region). Support region 31A is defined as follows. That is, as shown in FIG. 2, a right reference line 11RC (a first right reference line) and a left reference line 11LC (a first left reference line) extending in the vehicle front/rear direction along a right end portion 11R and a left end portion 11L of seat 11 in the vehicle width direction are defined respectively. Further, as shown in FIGS. 2 and 5, when support region 31A of reinforcing member 31 is projected upward in the vertical direction, a first projection image 31M is formed by projection thereof. First projection image 31M is located on a front side relative to a front end portion 11T of seat 11, and is located between right reference line 11RC and left reference line 11LC. Reinforcing member 31 has support region 31A defined as described above.

### Functions and Effects

As described above, vehicle lower structure 10 is not provided with a member generally called a floor panel or the like, which is constituted by a metal steel plate or the like. Support region 31A of reinforcing member 31 is a region that is likely to receive a load of an occupant sitting in seat 11. Even if the rigidity of only intermediate member 21 is insufficient to receive the load, the presence of reinforcing member 31 allows intermediate member 21 and reinforcing member 31 to cooperate to receive the load of the occupant. That is, according to vehicle lower structure 10 in the first embodiment, it is possible to ensure rigidity by the presence of reinforcing member 31, and to suppress an increase in weight of vehicle lower structure 10 by the presence of the region in which reinforcing member 31 is not provided below seat 11 in the vehicle up/down direction.

Further, reinforcing member 31 may have at least support region 31A defined as described above. With such a configuration, it is possible to ensure rigidity and to suppress an increase in the weight of vehicle lower structure 10.

In the first embodiment described above, reinforcing member 31 is provided to extend from front member 16F toward the rear side in the vehicle front/rear direction. Reinforcing member 31 is not limited to being disposed on upper surface 21U of intermediate member 21, and may be disposed to be embedded in intermediate member 21. Further, reinforcing member 31 may be provided at a position spaced apart from front member 16F. Reinforcing member 31 may be provided to straddle side members 16L and 16R, for example. At least a portion of intermediate member 21 may be disposed between the pair of vehicle body frame members, and the pair of vehicle body frame members may be any two members selected from the pair of side members 16L and 16R, front member 16F, and cross member 17. When reinforcing member 31 is bonded to front member 16F and side members 16L and 16R, reinforcing member 31 can resist a greater load.

### (Reinforcing Member 32)

Referring to FIGS. 2 and 5, here, reinforcing member 32 is provided to extend from cross member 17 toward the rear side in the vehicle front/rear direction. Reinforcing member 32 may be detachably or non-detachably bonded to cross member 17.

Reinforcing member 32 has a support region 32A (a second support region). Support region 32A is defined as follows. That is, as shown in FIG. 2, a right reference line 12RC (a second right reference line) and a left reference line 12LC (a second left reference line) extending in the vehicle front/rear direction along a right end portion 12R and a left end portion 12L of seat 12 in the vehicle width direction are defined respectively. Further, as shown in FIGS. 2 and 5, when support region 32A of reinforcing member 32 is projected upward in the vertical direction, a second projection image 32M is formed by projection thereof. Second projection image 32M is located on a front side relative to a front end portion 12T of seat 12, and is located between right reference line 12RC and left reference line 12LC. Reinforcing member 32 has support region 32A defined as described above.

Support region 32A of reinforcing member 32 is a region that is likely to receive a load of an occupant sitting in seat 12. Even if the rigidity of only intermediate member 22 is insufficient to receive the load, the presence of reinforcing member 32 allows intermediate member 22 and reinforcing member 32 to cooperate to receive the load of the occupant. That is, according to vehicle lower structure 10 in the first embodiment, it is possible to ensure rigidity by the presence of reinforcing member 32, and to suppress an increase in the weight of vehicle lower structure 10.

Reinforcing member 32 is satisfactory as long as it has at least support region 32A defined as described above. With such a configuration, it is possible to ensure rigidity and to suppress an increase in the weight of vehicle lower structure 10.

In the first embodiment described above, reinforcing member 32 is provided to extend from cross member 17 toward the rear side in the vehicle front/rear direction. Reinforcing member 32 is not limited to being disposed on upper surface 22U of intermediate member 22, and may be disposed to be embedded in intermediate member 22. Further, reinforcing member 32 may be provided at a position spaced apart from cross member 17. Reinforcing member 32 may be provided to straddle side members 16L and 16R, for example. Reinforcing member 32 may be provided to extend from cross member 18 toward the front side in the vehicle front/rear direction, and when cross member 18 is not provided, reinforcing member 32 may be provided to extend from rear member 16B toward the front side in the vehicle front/rear direction. When reinforcing member 32 is bonded to these members, reinforcing member 32 can resist a greater load.

### Second Embodiment

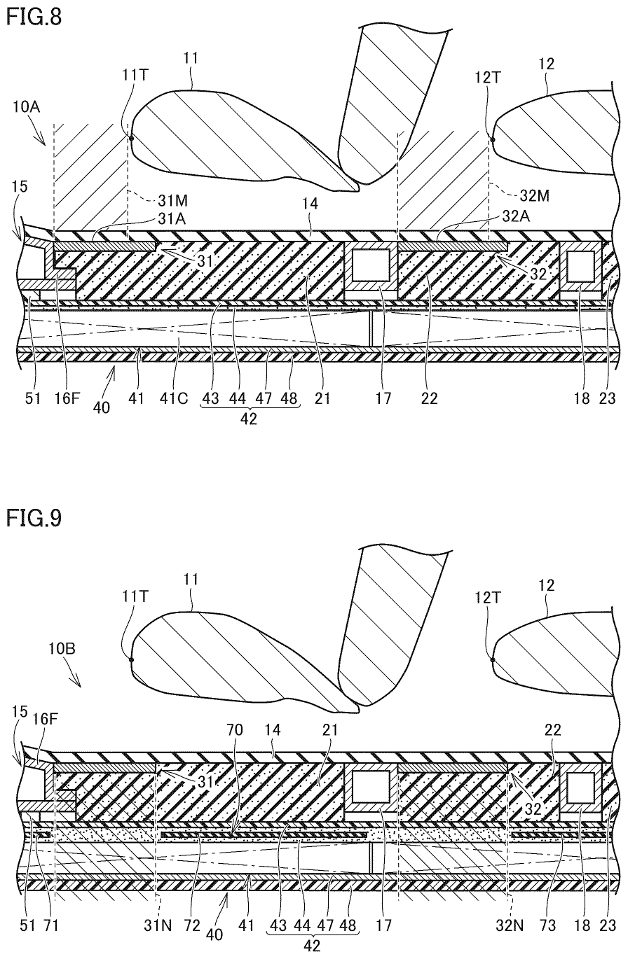

FIG. 8 is a cross sectional view showing a vehicle lower structure 10A in a second embodiment, which corresponds to FIG. 5 in the first embodiment.

In the first embodiment described above, the entire upper surface of reinforcing member 31 constitutes support region 31A, and first projection image 31M formed by projection of support region 31A is located on the front side relative to front end portion 11T of seat 11, and is located between right reference line 11RC and left reference line 11LC.

In the second embodiment, a portion of the upper surface of reinforcing member 31 constitutes support region 31A. In other words, support region 31A corresponds to a region corresponding to a portion located on the front side relative to front end portion 11T of seat 11 and located between right reference line 11RC and left reference line 11LC when the upper surface of reinforcing member 31 is projected in the same manner as that described above. Also with such a configuration, the same functions and effects as those in the first embodiment can be obtained.

Similarly, in the second embodiment, a portion of an upper surface of reinforcing member 32 constitutes support region 32A. In other words, support region 32A corresponds to a region corresponding to a portion located on the front side relative to front end portion 12T of seat 12 and located between right reference line 12RC and left reference line 12LC when the upper surface of reinforcing member 32 is projected in the same manner as that described above. Also with such a configuration, the same functions and effects as those in the first embodiment can be obtained.

### Third Embodiment

FIG. 9 is a cross sectional view showing a vehicle lower structure 10B in a third embodiment, which corresponds to FIG. 5 in the first embodiment.

In vehicle lower structure 10B, power storage device 40 further includes a rigid board 70. Rigid board 70 can function as a reinforcing member for top plate 43 constituting case 42 of power storage device 40. Rigid board 70 is satisfactory when it is configured to have a material or a structure having strength higher than that of top plate 43, for example. In the present embodiment, rigid board 70 has a plurality of board pieces 71 to 73, and each of the plurality of board pieces 71 to 73 is disposed between top plate 43 and power storage module 41.

Here, when reinforcing member 31 is projected downward in the vertical direction, at least a portion of a third projection image 31N formed by projection thereof is located not to overlap rigid board 70 (that is, the plurality of board pieces 71 to 73). Similarly, when reinforcing member 32 is projected downward in the vertical direction, at least a portion of a third projection image 32N formed by projection thereof is located not to overlap rigid board 70 (that is, the plurality of board pieces 71 to 73).

The fact that third projection images 31N and 32N of reinforcing members 31 and 32 are located not to overlap rigid board 70 means that rigid board 70 is not present at those locations. Even if there is a portion where rigid board 70 is not present as described above, rigidity can be ensured by the presence of reinforcing members 31 and 32. Since the presence of rigid board 70 is omitted, the vehicle lower structure can be manufactured at a lower cost correspondingly.

### Fourth Embodiment

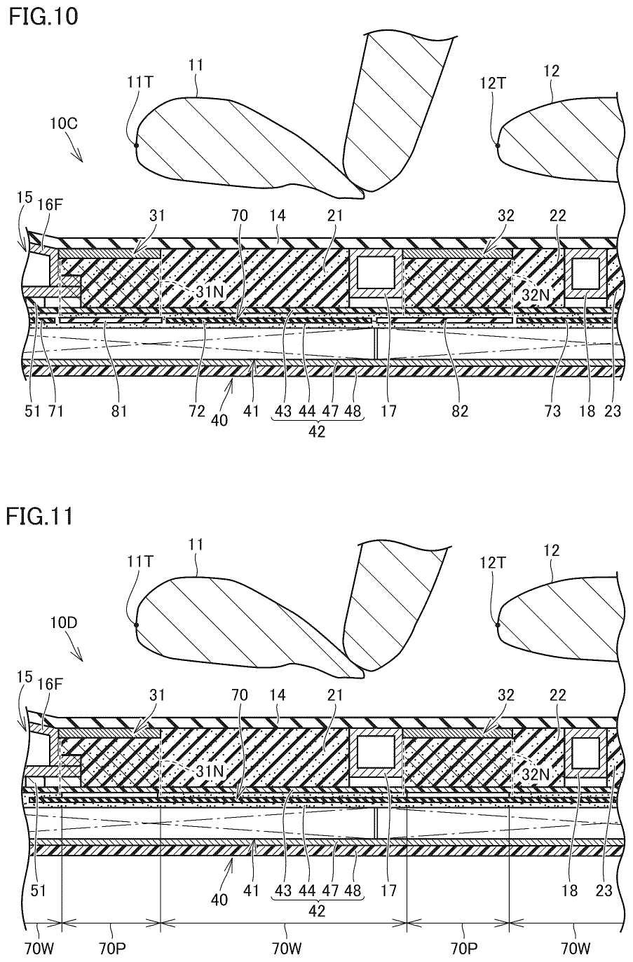

FIG. 10 is a cross sectional view showing a vehicle lower structure 10C in a fourth embodiment, which corresponds to FIG. 5 in the first embodiment. The fourth embodiment can be implemented as a modification of the third embodiment described above.

In vehicle lower structure 10C, power storage device 40 further includes cushion members 81 and 82. Cushion members 81 and 82 are disposed between top plate 43 and power storage module 41. When reinforcing members 31 and 32 are projected downward in the vertical direction, at least portions of third projection images 31N and 32N formed by projection thereof are located to overlap cushion members 81 and 82.

Even if there is a portion where rigid board 70 is not present as described above in the third embodiment described above, cushion members 81 and 82 are present to fill such a portion. Cushion members 81 and 82 are satisfactory when they are constituted by members which are less expensive than rigid board 70 and adhesive 44, for example. According to such a configuration, the vehicle lower structure can be manufactured at a lower cost.

### Fifth Embodiment

FIG. 11 is a cross sectional view showing a vehicle lower structure 10D in a fifth embodiment, which corresponds to FIG. 5 in the first embodiment. The fifth embodiment can be implemented as a modification of the third embodiment described above.

In vehicle lower structure 10D, rigid board 70 has underlying portions 70P underlying third projection images 31N and 32N, and non-underlying portions 70W not underlying third projection images 31N and 32N. That is, when reinforcing members 31 and 32 are projected downward in the vertical direction, third projection images 31N and 32N formed by projection thereof are located to overlap underlying portions 70P of rigid board 70.

Here, underlying portion 70P of rigid board 70 is not bonded to top plate 43, and as shown in FIG. 11, adhesive 44 is not present between underlying portion 70P of rigid board 70 and top plate 43. On the other hand, at least a portion of rigid board 70 other than underlying portion 70P (non-underlying portion 70W) is bonded to top plate 43. In the present embodiment, substantially entire rigid board 70 other than underlying portions 70P is bonded to top plate 43. Since adhesive 44 is not present between underlying portion 70P of rigid board 70 and top plate 43, the vehicle lower structure can be manufactured at a lower cost correspondingly.

Further, in a non-bonded range of underlying portion 70P, a space is formed, because adhesive 44 is not present. When a load is inputted from an upper surface side of a floor, the floor is deformed, intermediate member 21 and the like are also deformed, and thereafter top plate 43 is also deformed. By absorbing (stroking) displacement associated with such deformation in the space, input of the load to rigid board 70 can be reduced.

### Sixth Embodiment

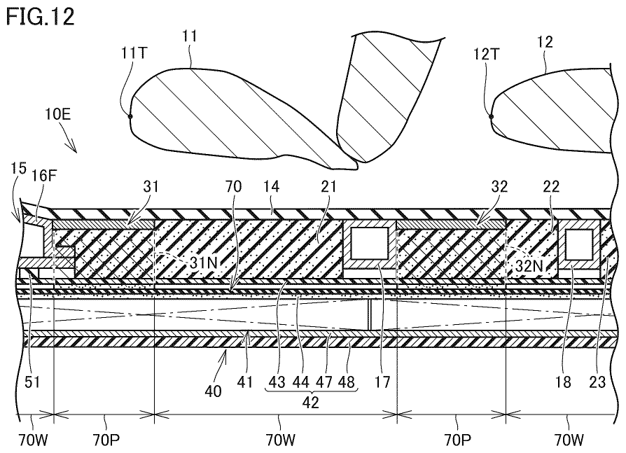

FIG. 12 is a cross sectional view showing a vehicle lower structure 10E in a sixth embodiment, which corresponds to FIG. 5 in the first embodiment. The sixth embodiment can be implemented as a modification of the third embodiment described above.

In vehicle lower structure 10E, underlying portion 70P of rigid board 70 is bonded to top plate 43, and as shown in FIG. 12, adhesive 44 is present between underlying portion 70P of rigid board 70 and top plate 43. On the other hand, at least a portion of rigid board 70 other than underlying portion 70P (non-underlying portion 70W) is not bonded to top plate 43. In the present embodiment, substantially entire rigid board 70 other than underlying portions 70P is not bonded to top plate 43. Since adhesive 44 is not present between non-underlying portion 70W of rigid board 70 and top plate 43, the vehicle lower structure can be manufactured at a lower cost correspondingly.

Further, since underlying portion 70P is likely to be located under the occupant's feet, rigid board 70 can be reinforced by bonding underlying portion 70P of rigid board 70 to top plate 43. On the other hand, the portion of rigid board 70 not underlying third projection image 31N (non-underlying portion 70W) below seat 11 is less likely to directly receive a load generated when the occupant taps his or her foot. Therefore, by not bonding non-underlying portion 70W of rigid board 70 to top plate 43, a space is formed at this position, and this space can absorb variation in vertical position between cross member 17 and the like and power storage device 40 and displacement due to relative vibration.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A vehicle lower structure comprising:
a pair of vehicle body frame members;
a first intermediate member at least a portion of which is disposed between the pair of vehicle body frame members;
a power storage device disposed below the first intermediate member;
a first seat disposed above the first intermediate member; and
a first reinforcing member disposed inside the first intermediate member or on an upper surface of the first intermediate member, wherein
the vehicle lower structure has a region in which the first reinforcing member is not provided below the first seat in a vehicle up/down direction.

2. The vehicle lower structure according to claim 1, comprising a lower frame including a pair of side members, a front member connecting front portions of the pair of side members, a rear member connecting rear portions of the pair of side members, and a cross member connecting intermediate portions of the pair of side members in a vehicle front/rear direction, wherein
the pair of vehicle body frame members are any two members selected from the pair of side members, the front member, and the cross member,
the first intermediate member is disposed to fill a space formed by the pair of side members, the front member, and the cross member, inside these members,
the first reinforcing member has a first support region, and
when a first right reference line and a first left reference line extending in the vehicle front/rear direction along a right end portion and a left end portion of the first seat in a vehicle width direction are defined respectively, and the first support region is projected upward in a vertical direction, a first projection image formed by projection thereof is located on a front side relative to a front end portion of the first seat, and is located between the first right reference line and the first left reference line.

3. The vehicle lower structure according to claim 2, wherein the first reinforcing member is provided to extend from the front member toward a rear side in the vehicle front/rear direction.

4. The vehicle lower structure according to claim 2, wherein
the lower frame includes a plurality of the cross members,
the vehicle lower structure further comprises a second intermediate member disposed to fill a space formed by the pair of side members and the plurality of the cross members, inside these members,
the power storage device is disposed below both the first intermediate member and the second intermediate member,
the vehicle lower structure further comprises a second seat, and a second reinforcing member disposed inside the second intermediate member or on an upper surface of the second intermediate member,
the second reinforcing member has a second support region, and
when a second right reference line and a second left reference line extending in the vehicle front/rear direction along a right end portion and a left end portion of the second seat in the vehicle width direction are defined respectively, and the second support region is projected upward in the vertical direction, a second projection image formed by projection thereof is located on a front side relative to a front end portion of the second seat, and is located between the second right reference line and the second left reference line.

5. The vehicle lower structure according to claim 4, wherein the second reinforcing member is provided to extend from any of the plurality of the cross members toward a front side or a rear side in the vehicle front/rear direction.

6. The vehicle lower structure according to claim 2, wherein
the power storage device includes
a power storage module including a plurality of power storage cells arranged in a horizontal direction,
a case having a top plate and a bottom plate and accommodating the power storage module, and
a rigid board disposed between the top plate and the power storage module, and
when the first reinforcing member is projected downward in the vertical direction, at least a portion of a third projection image formed by projection thereof is located not to overlap the rigid board.

7. The vehicle lower structure according to claim 6, wherein
the power storage device further includes a cushion member disposed between the top plate and the power storage module, and
at least a portion of the third projection image is located to overlap the cushion member.

8. The vehicle lower structure according to claim 6, wherein
the rigid board has an underlying portion underlying the third projection image,
the underlying portion of the rigid board is not bonded to the top plate, and
at least a portion of the rigid board other than the underlying portion is bonded to the top plate.

9. The vehicle lower structure according to claim 6, wherein
the rigid board has an underlying portion underlying the third projection image,
the underlying portion of the rigid board is bonded to the top plate, and
at least a portion of the rigid board other than the underlying portion is not bonded to the top plate.
